(19) United States
(12) Patent Application Publication
(10) Pub. No.: US 2007/0176860 A1
(43) Pub. Date: Aug. 2, 2007

(54) DISPLAY APPARATUS

(75) Inventors: Byung-sik KOH, Gwangmyeong-si (KR); Chun-seok KO, Hwaseong-si (KR); Si-duk SUNG, Seoul (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD.,, Suwon-si (KR)

(21) Appl. No.: 11/670,127

(22) Filed: Feb. 1, 2007

(30) Foreign Application Priority Data
Feb. 2, 2006 (KR) 102006010010
Mar. 3, 2006 (KR) 1020060020339

(51) Int. Cl. G09G 3/30

(52) U.S. Cl. 345/76

(57) ABSTRACT

A display apparatus includes an insulating substrate having a display region, a light emitting layer formed in the display region, a first voltage pad applying a reference voltage to the display region, the first voltage pad being formed in a non-display region on the insulating substrate, a frame supporting the insulating substrate and including an insulating material, a second voltage pad formed on the frame and electrically connected with the first voltage pad and a power supplying part supplying power to the second voltage pad, the power supplying part being formed on the frame.

This application claims priority to Korean Patent Application Nos. 2006-0010010 (filed on Feb. 2, 2006) and 2006-0020339 (filed on Mar. 3, 2006), the disclosures of which are incorporated herein by reference in their entirety.

### BACKGROUND OF THE INVENTION

1. Field of the Invention

The present invention relates to a display apparatus and a manufacturing method thereof, and more particularly, to a display apparatus, which is supplied with a driving voltage or a common voltage efficiently, and a manufacturing method thereof.

2. Description of the Related Art

Among flat panel displays, an OLED (organic light emitting diode) is being spotlighted because of its low driving voltage, light-weight and thinness, wide viewing angle, high speed response, etc.

The OLED includes a substrate on which a plurality of driving thin film transistors are formed. An anode electrode to form a pixel, and a cathode electrode serving to provide a reference voltage, are formed on the thin film transistors. When a voltage is applied to both electrodes, holes and electrons are recombined to generate excitons. The generated excitons emit light while transitioning into a ground state in a light emitting layer interposed between both electrodes. The OLED displays images by controlling the emitted light.

On the OLED substrate are formed a switching transistor at an intersection of a gate line and a data line, and a driving transistor connected to a driving voltage line to apply a driving voltage, in order to form one pixel. In addition, on the OLED substrate is formed a voltage supplying pad to supply a common voltage as a reference voltage to be applied to the cathode electrode and the driving voltage to be applied to the driving voltage line.

As sizes of display apparatus grow and become relatively large, the number of pixels increases for high resolution. Consequently, the common voltage and the driving voltage have to be supplied sufficiently for these larger size display apparatus. In a convention display apparatus, the common voltage and the driving voltage are supplied from a lateral side of a substrate using a PCB (printed circuit board) and a FPC (flexible printed circuit), instead of a gate or data driving IC, in order to supply power stably and improve uniformity of the whole substrate.

However, when the common voltage and the driving voltage are supplied by using the FPC, the common voltage and the driving voltage may drop due to resistors included in the PCB and the FPC connected to the OLED substrate. Moreover, the PCB and the FPC increase product costs as well as the overall size of the OLED substrate.

### BRIEF SUMMARY OF THE INVENTION

Exemplary embodiments provide a display apparatus, which is capable of providing uniform brightness by supplying a driving voltage or a common voltage efficiently, and a manufacturing method thereof.

An exemplary embodiment provides a display apparatus including an insulating substrate having a display region, a light emitting layer formed in the display region, a first voltage pad applying a reference voltage to the display region, the first voltage pad being formed in a non-display region on the insulating substrate, a frame supporting the insulating substrate and including an insulating material, a second voltage pad formed on the frame and electrically connected with the first voltage pad and a power supplying part supplying power to the second voltage pad, the power supplying part being formed on the frame.

In an exemplary embodiment, the second voltage pad includes a conductive pattern formed on the frame.

In an exemplary embodiment, the first voltage pad and the second voltage pad each include at least one of a metal layer, an ITO (indium tin oxide) layer and an IZO (indium zinc oxide) layer.

In an exemplary embodiment, the second voltage pad contacts the first voltage pad.

In an exemplary embodiment, the second voltage pad corresponds to the first voltage pad and is contacted with the first voltage pad.

In an exemplary embodiment, the display apparatus further includes a driving voltage line formed in the display region. The first voltage pad applies a driving voltage to the driving voltage line.

In an exemplary embodiment, the display apparatus further includes a common electrode formed in the display region. The first voltage pad applies a common voltage to the common electrode.

In an exemplary embodiment, the light emitting layer emits light through a first side of the insulating substrate the first side being not covered by the frame.

In an exemplary embodiment, the display apparatus further includes an auxiliary voltage pad interconnecting a plurality of the first voltage pad. Each of pairs of the plurality of the first voltage pad is disposed opposite to each other relative to the display region.

In an exemplary embodiment, the auxiliary voltage pad includes a FPC (flexible printed circuit).

In an exemplary embodiment, a plurality of the auxiliary voltage pad is arranged in parallel.

In an exemplary embodiment, the display apparatus further includes an anisotropic conductive film provided between the first voltage pad and the second voltage pad.

An exemplary embodiment provides a display apparatus including an insulating substrate having a display region, a light emitting layer formed in the display region, a voltage pad applying a reference voltage to the display region, the voltage pad being formed in a peripheral portion of the insulating substrate in a non-display region, a frame supporting the insulating substrate and including an insulating material; a conductive member formed on the frame and electrically connected with the voltage pad and a power supplying part supplying power to the conductive member, the power supplying part being formed on the frame.

An exemplary embodiment provides a display apparatus including an insulating substrate having a display region, a light emitting layer formed in the display region, a voltage pad applying a reference voltage to the display region, the voltage pad being formed in a peripheral portion of a non-display region on the insulating substrate, an insulating frame supporting the insulating substrate, a power supplying pin formed on an inner surface of the frame and electrically connected with the voltage pad and a power supplying part supplying power to the power supplying pin, the power supplying part being formed on the frame.

In an exemplary embodiment, the power supplying pin presses the insulating substrate.

In an exemplary embodiment, the power supplying pin includes a head contacting the voltage pad and a pressing member pressing the head against the voltage pad.

In an exemplary embodiment, a length of the pressing member is adjustable in a direction perpendicular to the inner surface with respect to a plane of the frame.

In an exemplary embodiment, the pressing member includes a spring.

In an exemplary embodiment, the voltage pad contacts the power supplying pin.

An exemplary embodiment provides a method of manufacturing a display apparatus. The method includes providing an insulating substrate including a light emitting layer formed in a display region and a voltage pad applying a reference voltage to the display region, the voltage pad being formed in a non-display region of the insulating substrate, providing an insulating frame including a power supplying pin formed on an inner surface of the frame and electrically connected with the voltage pad and a power supplying part supplying power to the power supplying pin, aligning the insulating substrate with the insulating frame so that the power supplying pin corresponds to the voltage pad, and combining the insulating substrate and the insulating frame together so that the power supplying pin contacts the voltage pad.

In an exemplary embodiment, a length of the power supplying pin is adjustable in a perpendicular direction to the inner surface and with respect to a plane of the insulating frame. A portion of the power supplying pin is inserted into the insulating frame when the insulating substrate is combined to the insulating frame.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a schematic view of an exemplary embodiment of a display panel according to the present invention;

FIG. 2 is a schematic view of an exemplary embodiment of a frame according to the present invention;

FIG. 3 is a cross-sectional view of an exemplary embodiment of a display apparatus according to the present invention;

FIG. 4 is an equivalent circuit diagram of an exemplary embodiment of a pixel according to the present invention;

FIG. 5 is a schematic view of another exemplary embodiment of a display panel according to the present invention;

FIG. 6A is a schematic view of another exemplary embodiment of a frame according to the present invention;

FIGS. 6B and 6C are a cross-sectional views of the frame taken along line VI-VI in FIG. 6A and an enlarged portion of the frame in FIG. 6B, respectively; and

FIGS. 7A and 7B are a cross-sectional views of another exemplary embodiment of a display apparatus according to the present invention.

### DETAILED DESCRIPTION OF THE INVENTION

This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “contacting” another element or layer, the element or layer can be directly on, connected or coupled to another element or layer or intervening elements or layers. In contrast, when an element is referred to as being “directly on,” “directly connected to” or “directly contacting” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “below”, “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” or “below” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Reference will now be made in detail to exemplary embodiments of the present invention, examples of which are illustrated in the accompanying drawings.

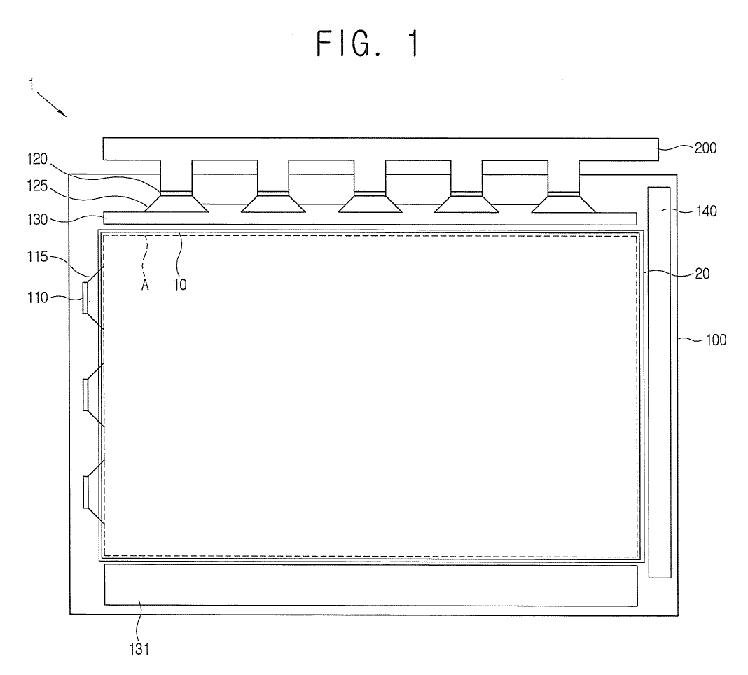

Referring to FIGS. 1 to 4, a display apparatus includes a display panel 1 and a frame 2 supporting the display panel 1. As shown in the figures, the display panel 1 includes a substrate 100, such as an insulating substrate, formed with a display region A (outlined by a broken line in FIG. 1), a gate driving part 110 and a data driving part 120, both of which are provided in a non-display region (e.g., a peripheral region of the substrate 100), and a plurality of first voltage pads 130, 131 and 140 disposed in the non-display region.

The first voltage pads 130, 131 and 140 include first driving voltage pads 130 and 131, which are spaced apart from each other (e.g., relative to the display region A) with the display region A interposed therebetween, and a first common voltage pad 140 opposite (e.g., relative to the display region A) to the gate driving part 110 with the display region A interposed therebetween. On the insulating substrate 100 are formed a common electrode 10 applying a common voltage to the display region A and a plate 20, such as a glass plate, covering the common electrode 10.

A circuit board 200, which provides a gate voltage and a data voltage to the display region A, is connected to the data driving part 120. In exemplary embodiments, the circuit board 200 may be provided as a FPC (flexible printed circuit) on which circuits to generate various voltages are mounted. After manufacturing of the display panel 1 is completed, the circuit board 200 may be folded into a back side of a portion of the display panel 1 where images are displayed. In one exemplary embodiment the circuit board 200 includes a form of flexible film.

A gate on/off voltage is provided to the gate driving part 110 through a wiring pattern (not shown) formed on the insulating substrate 100.

The display region A shown in FIG. 1 includes gate lines (not shown), data lines and driving voltage lines (not shown) which extend perpendicular to the gate lines, and a plurality of pixels defined by intersections of these lines. The driving voltage lines are formed in parallel to the data lines. The driving voltage lines may be provided as a data metal layer and may be formed on the same layer as the data lines.

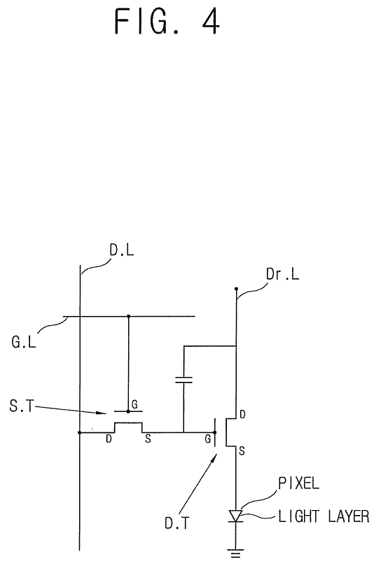

An equivalent circuit of an exemplary embodiment of a pixel formed below the common electrode 10 will be described with reference to FIG. 4.

As shown in this figure, a pixel includes a switching transistor S.T electrically connected to a gate line G.L and a data line D.L, a driving transistor D.T electrically connected to a source electrode S of the switching transistor S.T and a driving voltage line Dr.L, and a pixel electrode PIXEL electrically connected to the driving transistor D.T. The pixel may further include a light emitting layer (not shown) to emit light upon receiving a voltage from the pixel electrode PIXEL.

The gate line G.L intersects the data line D.L and the driving voltage line Dr.L substantially perpendicularly, thereby defining one pixel. A gate metal layer including the gate line G.L and gate electrodes G of the transistors S.T and D.T may be provided as a single layer or a multi layer. The gate line G.L applies a gate on/off voltage to the switching transistor S.T connected to the gate line G.L.

A data metal layer, which includes the data line D.L intersecting the gate line G.L, and drain electrodes D and source electrodes S of the transistors S.T and D.T, is provided to be electrically isolated from the gate metal layer. The data line D.L applies a data voltage to the switching transistor S.T.

The driving voltage line Dr.L is provided in parallel to the data line D.L and intersects the gate line G.L to form the pixel. Accordingly, a plurality of pixels are provided in a substantially matrix shape pattern. The driving voltage line Dr.L is provided as a data metal layer and may be formed on the same layer as the data line D.L.

The driving voltage line Dr.L may be arranged for each pixel or may be shared by two pixels. In one exemplary embodiment, two pixels arranged adjacent to the driving voltage line Dr.L can receive a driving voltage from one driving voltage line Dr.L. Such a line-reduced structure where two pixels share one driving voltage line Dr.L may make a manufacturing process simpler, and allow portions to which a voltage is applied to be reduced, thereby reducing an EMI (electromagnetic interference) effect.

The switching transistor S.T include the gate electrode G formed as a portion of the gate line G.L, the drain electrode D branched from the data line D.L, the source electrode S separated from the drain electrode D, and a semiconductor layer (not shown) formed between the drain electrode D and the source electrode S. A gate on voltage applied to the gate line G.L is transmitted to the gate electrode G of the switching transistor S.T. Then, a data voltage applied from the data line D.L is transmitted to the source electrode S through the drain electrode D.

The driving transistor D.T controls current flowing between its drain electrode D and its source electrode S according to the data voltage applied to its gate electrode G. A voltage supplied to the pixel electrode PIXEL through the source electrode S of the driving transistor D.T corresponds to a difference between the data voltage applied to the gate electrode S and a driving voltage applied to the drain electrode D.

The pixel electrode PIXEL is provided as an anode electrode to provide holes to the light emitting layer.

In a front of the display region A is provided the common electrode 10 through which current flows out of the light emitting layer.

Retuning to FIG. 1, in one side of the non-display region are formed the gate driving part 110 connected to an end of the gate line and on another side of the non-display region (e.g., adjacent to the one side) the data driving part 120 is connected to an end of the data line. The gate driving part 110 and the data driving part 120 apply various driving signals, which are received from the outside, to the gate line and the data line.

In an exemplary embodiment, the gate driving part 110 and the data driving part 120 are provided as a COG (chip on glass) mounted on the insulating substrate 100. Alternatively, these driving parts 110 and 120 may be mounted by a TCP (tape carrier package) method. The driving parts may be attached on a polymer film a COF (chip on film) method where the driving parts are mounted on a circuit board, or the like.

The gate line and the data line in the display region A are extended to an outer region of the of the display region and are connected to the gate driving part 110 and the data driving part 120, respectively. In connection portions between the gate line and the data line, and the gate driving part 110 and the data driving part 120, respectively, are formed a gate fan-out part 115 and a data fan out part 125. An interval between the extended gate lines of the gate fan out part 115 becomes narrower in a direction from the display region A towards the gate driving part 110. An interval between the extended data lines of the data fan out part 125 becomes narrower from the display region A towards the data driving part 120.

In the non-display region are formed the first upper driving voltage pad 130 connected to a first end of the driving voltage line and the first lower driving voltage pad 131 connected to a second end of the driving voltage line opposite to the first end. The first upper driving voltage pad 130 has a substantially funnel shape formed between data driving parts 120 and a substantially rod shape formed in parallel to the gate line.

The funnel shape and rod shape portions form an integrated first upper driving voltage pad 130. In an exemplary embodiment, the first upper driving voltage pad 130 of includes the same gate metal material as the gate line. The first upper driving voltage pad 130 and the first lower driving voltage pad 131, which are not connected to the circuit board 200, receive power through the frame 2, which will be described later. The terms ‘upper’ and ‘lower’ may be exchangeable to distinguish between two first driving voltage pads 130 and 131. As used herein, “integrated” is used to indicate formed to be a single unit or piece rather than combining separate elements.

The first common voltage pad 140 is provided at an opposite side to the gate driving part 110 relative to the display region A with the display region A interposed therebetween. The first common voltage pad 140 is connected to the common electrode 10 and applies the common voltage, which is received from the outside, to the common electrode 10. Although in the illustrated embodiment of FIG. 1 the common electrode 10 is shown separated from the first common voltage pad 140, the common electrode 10 may be connected to the first common voltage pad 140 directly or via a bridge electrode (not shown) including such material as ITO (indium tin oxide).

In exemplary embodiments, the first voltage pads 130, 131 and 140 may include any of a number of conductive metal layers as well as the gate metal material, or ITO or IZO (indium zinc

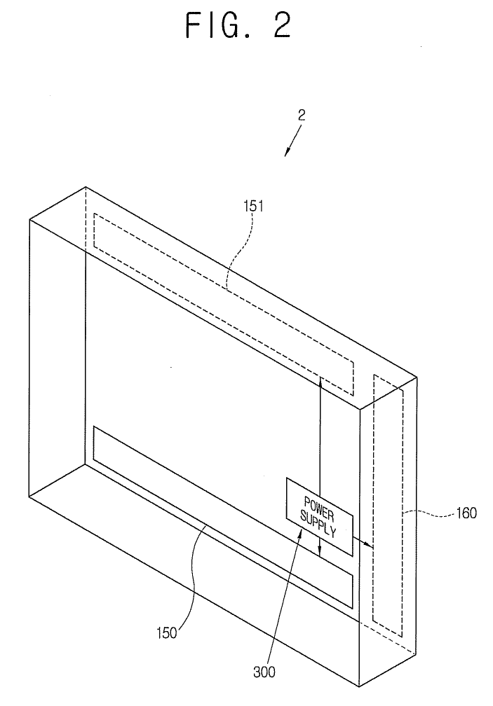

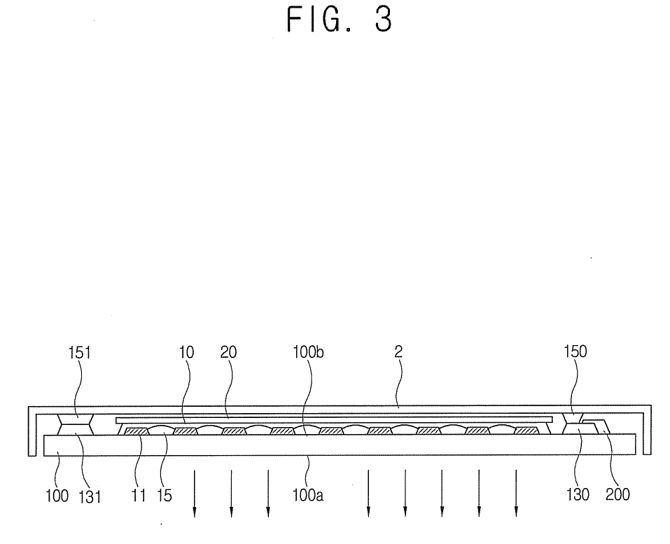

As shown in FIGS. 2 and 3, the frame 2 includes second driving voltage pads 150 and 151 electrically connected to the first driving voltage pads 130 and 131, respectively, a second common voltage pad 160 electrically connected to the first common voltage pad 140, and a power supplying part 300 supplying corresponding voltages to the second driving voltage pads 150 and 151 and the second common voltage pad 160. The second voltage pads 150, 151 and 160 may correspond in location, position and/or size with the first voltage pads 130, 131 and 140.

The frame 2 encloses and supports the insulating substrate 100 after interconnection of all signal wirings on the insulating substrate 100 is completed. The frame 2 may include an insulating material to prevent the frame 2 from being electrically connected to a plurality of signal wirings formed on the insulating substrate 100 and the first voltage pads 130, 131 and 140. The frame 2 may include a relatively light and strong material such as plastic. In this embodiment, the second driving voltage pads 150 and 151 and the second common voltage pad 160 are formed at an inner surface of the frame 2 contacting the insulating substrate 100, the frame 2 having a substantially rectangular shape.

As in the illustrated embodiment, the display apparatus does not include a PCB and a FPC to apply the common voltage and the driving voltage to the display panel 1 on which thin film transistors and signal wirings are formed. Instead, the power supplying part 300 supplying the common voltage and the driving voltage is provided outside the display panel 1 so as to make the display panel 1 relatively smaller. Advantageously, the power supplying part 300 is provided in the frame 2 supporting the display panel 1 in combination with the existing display panel 1, and therefore, there is no need to manufacture an additional component.

In the illustrated embodiment, the second driving voltage pads 150 and 151 and the second common voltage pad 160 are formed in a conductive pattern including a transparent conductive material such as ITO or IZO. Alternatively, these pads 150, 151 and 160 may be formed by patterning other various conductive metals, such as the gate metal material and the data metal material.

In an exemplary embodiment the second driving voltage pads 150 and 151 and the second common voltage pad 160 may make direct contact with the first driving voltage pads 130 and 131 and the first common voltage pad 140, respectively, without a separate medium.

The first driving voltage pads 130 and 131 and the first common voltage pad 140 formed on the display panel 1, and the second driving voltage pads 150 and 151 and the second common voltage pad 160 formed on the frame 2 are provided in a conductive pattern in a one-to-one correspondence, forming a direct contact therebetween. There are various methods in which a driving voltage or a common voltage supplied from the outside of the frame 2 is transmitted to the display substrate 1. In one exemplary embodiment, a contact method using a metal pattern has an advantage in that a voltage can be directly transmitted to the display substrate 1. In addition, since the display substrate 1 does not have a FPC or a PCB, a voltage drop may decrease, which results in improvement of uniformity of the display apparatus.

The arrangement of the first driving voltage pads 130 and 131 and the first common voltage pad 140 is not limited to the illustrated embodiment. In an exemplary embodiment, the first common voltage pad 140 may be provided as a pair with the display region A interposed therebetween (e.g., a first common voltage page 140 on opposite sides of the display region A). In addition, if the display apparatus is relatively small in size, the number of the driving voltage pads (e.g., 130, 131, 150, 151) may be singular, not plural. In an exemplary embodiment, the first lower driving voltage pad 131 may not necessarily be formed at a side of the display region A to which the circuit board 200 is not connected and opposite to the first upper driving voltage pad 130 formed at the same side as the data driving part 120 to control a voltage drop according to resistance similarly.

In an exemplary embodiment, although the first voltage pads 130, 131 and 140 may be provided to have a bar shape along sides of the display region A in the illustrated embodiment, the first voltage pads 130, 131 and 140 may be provided as a plurality of fragments which are separated from each other along their respective side of the display region A.

In exemplary embodiments, the power supplying part 300 includes a circuit to generate the driving voltage and the common voltage independently. The power supplying part 300 may be controlled by a controller (not shown) connected to the circuit board 200.

FIG. 3 is a cross-sectional view of an exemplary embodiment of a display apparatus. As shown in the figure, light emitting layers 15 including an organic material emitting light and partitions 11 to partition the light emitting layers 15 are formed on pixels of the insulating substrate 100. The display panel 1 is combined with and supported by the frame 2.

In the display apparatus of the illustrated embodiment, the light from the light emitting layer 15 is emitted through a first surface 100a of the insulating substrate 100 which is not covered by the frame 2. In other words, the first voltage pads 130, 131 and 140 and the circuit board 200 are formed on a second surface 100b of the insulating substrate 100 through which the light is emitted.

In an alternative embodiment, the display apparatus may further include an anisotropic conductive film (not shown) between the first voltage pads 130, 131 and 140 and the second voltage pads 150, 151 and 160, respectively. The anisotropic conductive film is considered a conductive adhesive film, such as made by adding conductive particles to a thermosetting resin film. When the anisotropic conductive film is attached, such as by heat-bonding, to the first and second voltage pads 130, 131, 140, 150, 151 and 160 after being aligned with these voltage pads, an electrical contact is made between these voltage pads. The electrical contact and attaching of the first and second voltage pads 130, 131, 140, 150, 151 and 160 may reduce or effectively prevent an unstable contact between the voltage pads and alleviate effects of a physical impact due to a contact between the insulating substrate 1 and the frame 2.

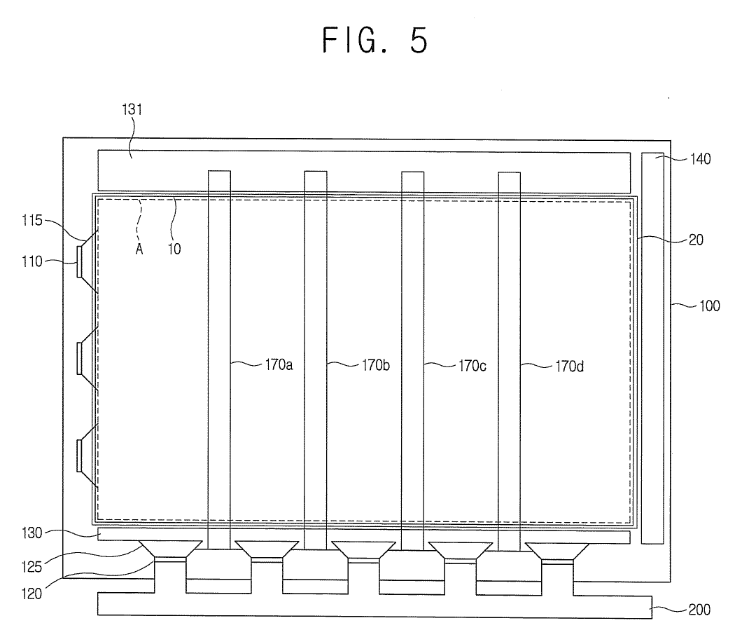

FIG. 5 is a schematic view of another exemplary embodiment of a display panel according to the present invention.

Referring to FIG. 5, the display panel includes a plurality of auxiliary voltage pads 170a, 170b, 170c and 170d each connected between the first driving voltage pads 130 and 131. The auxiliary voltage pads 170a, 170b, 170c and 170d transmit a driving voltage applied to one of the first driving voltage pads 130 and 131 to the other of the voltage pads 130 and 131. If there occurs a defective contact between one of the first driving voltage pads 130 and 131 and a corresponding one of the second driving voltage pads 150 and 151 or if there arises a problem in voltage delivery therebetween, a voltage applied to the other of the first driving voltage pads 130 and 131 may be transmitted to the display region A via the auxiliary voltage pads 170a, 170b, 170c and 170d.

In exemplary embodiments, the auxiliary voltage pads 170a, 170b, 170c and 170d may include a metal material, such as copper, having a low resistance. The auxiliary voltage pads 170a, 170b, 170c and 170d may be a FPC, similar to the circuit board 200. When a voltage is transmitted through the plurality of auxiliary voltage pads 170a, 170b, 170c and 170d, it is not necessary that the auxiliary voltage pads 170a, 170b, 170c and 170d have the same area (e.g., dimensions as viewed in a plane) and are isolated from each other in parallel at the same interval to control voltage drop according to resistance similarly as illustrated. The auxiliary voltage pads may be of varying sizes (e.g., areas) and/or be spaced at varying intervals in a direction (e.g., a longitudinal direction) of the display panel 1.

In an exemplary embodiment, the auxiliary voltage pads 170a, 170b, 170c and 170d may be detachably combined with the first driving voltage pads 130 and 131.

In an exemplary embodiment, if the first common voltage pad 140 is provided as a pair with the display region A interposed therebetween, an auxiliary voltage pad may be formed to connect between the pair of first common voltage pads 140.

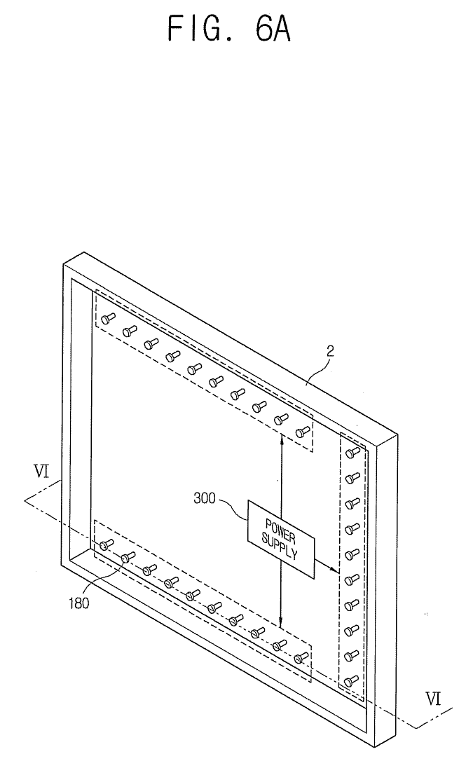

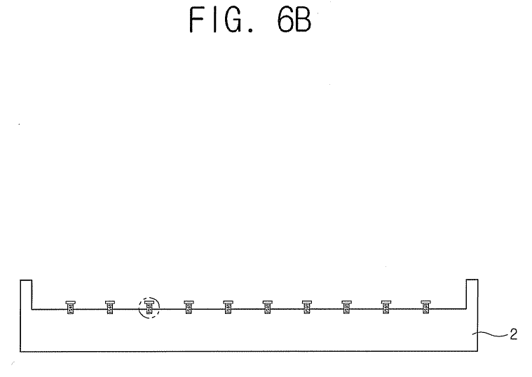

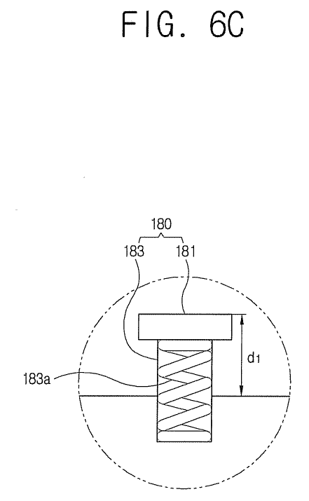

FIG. 6A is a schematic view of an exemplary embodiment of a frame according to the present invention, FIG. 6B is a cross-sectional view of the frame, taken along line VI-VI in FIG. 6A and FIG. 6C is an enlarged portion of FIG. 6B.

As shown in FIG. 6A, the frame 2 includes a plurality of power supplying pins 180 formed on a region corresponding to the voltage pads 130, 131 and 140. A power supplying part 300 supplies a fixed level of voltage to the power supplying pins 180.

In the illustrated embodiment, the power supplying pins 180 are formed substantially in a plane (e.g., parallel to the second surface 100b) contacting the insulating substrate 100 (see FIG. 1) inside the rectangular frame 2. The frame 2 including the power supplying pins 180 is combined with the insulating substrate 100 to supply power to the voltage pads 130, 131 and 140.

Referring to FIG. 6C, each of the power supplying pins 180 includes a head 181 to contact the voltage pads 130, 131 and 140, and a pressing member 183 supplying a force such that the power supplying pins 180 (via the head 181) press (e.g., apply pressure to) the insulating substrate 100. The voltage supplying pins 180 project from an inner surface of the frame 2 outwardly. Lengths by which the voltage supplying pins 180 project from the frame 2 may be adjusted.

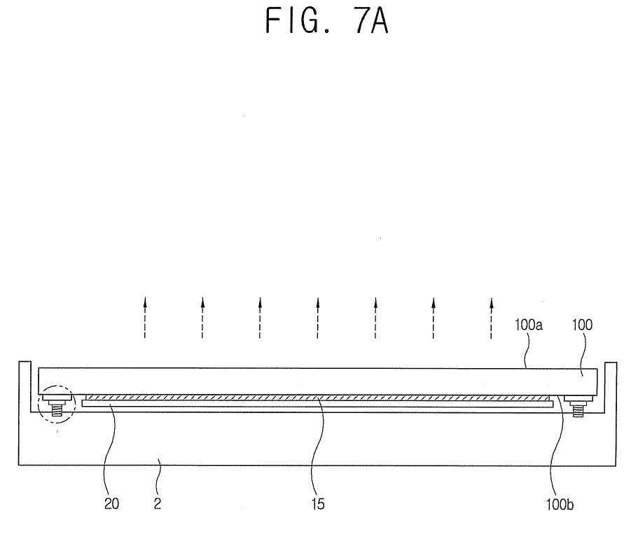

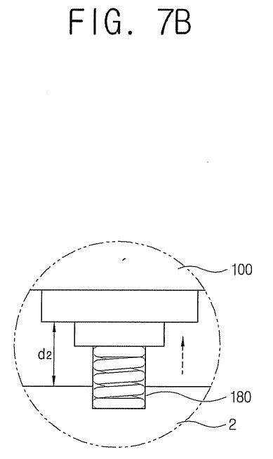

The voltage supplying pins 180 are designed in such a manner that their height (e.g., length) perpendicular to a plane of the frame 2 may be adjusted. As shown in FIG. 6C, a projecting height d1 indicates a length from an upper surface of the head 181 to the inner surface of the frame. Projecting height d1 is defined before the voltage supplying pins 180 contacts the insulating substrate 100 when the frame is combined with the insulating substrate 100. The projecting height decreases, such as to a height d2 (FIG. 7) after the contact of the voltage supplying pins 180 with the insulating substrate 100.

The head 181 of each voltage supplying pin 180 includes a metal material and makes direct contact with the voltage pads 130, 131 and 140 of the insulating substrate 100. The head 181 provides the driving voltage and the common voltage, which are supplied from the power supplying part 300, to the voltage pads 130, 131 and 140. Accordingly, the head 181 is formed at a corresponding portion of the voltage pads 130, 131 and 140. An area of the head 181 contacting the voltage pads 130, 131 and 140 may be adjusted according to the level of voltage or the magnitude of voltage. A number of heads 181 to which power is supplied may be set according to the level of voltage, the magnitude of voltage, size of the display, etc.

The pressing member 183 is disposed between and connects the frame 2 and the head 181, and is compressed by the insulating substrate 100. As in the illustrated embodiment, the pressing member 183 includes a spring 183a as a pressing means. When an external force is applied to the spring 183a (e.g., via the head 181), the spring 183a produces an elastic force opposing the applied external force.

FIG. 7 is a cross-sectional view of an exemplary embodiment of a display apparatus, showing a contact between the frame 20 and the insulating substrate 100. As shown in the figure, on the insulating substrate 100 is formed the light emitting layer 15, including an organic material or the like, to emit light to the outside of the display apparatus. The display panel 1, including the substrate 100, is combined with and supported by the frame 2. In the display apparatus of the illustrated embodiment, the light from the light emitting layer 15 is emitted through the first surface 100a of the insulating substrate 100 which is not covered by the frame 2.

After the insulating substrate 100 is aligned with the frame 2 so that the power supplying pins 180 correspond to the voltage pads 130, 131 and 140, when the insulating substrate 100 and the frame 2 contact each other by pressing one of the insulating substrate 100 and the frame 2 against the other, a portion of the power supplying pins 180 (e.g., a portion protruding from the frame 2) is inserted into the frame 2. As the projecting length of the power supplying pins 180 becomes reduced by contraction of the spring 183a and, at the same time, since the head 181 is pressed, the head 181 can adhere (e.g., be contacted) closely to the voltage pads 130, 131 and 140. Advantageously, the spring 183a simultaneously performs the adjustment to the height of the power supplying pins 180 and provides the close adhesion for power supply.

After the head 181 adheres closely to the voltage pads 130, 131 and 140, the projecting height d2 of the power supplying pins 180 may be small to minimize the thickness of the display apparatus.

In exemplary embodiments, any of a number of compression members other than the spring 183a may be used if the member can press the insulating substrate 100 as is suitable for the purpose described herein. A conductive film or the like may be inserted between the voltage pads 130, 131 and 140 and the head 181 in order to strengthen an electrical contact therebetween.

As in the illustrated embodiments, the display apparatus according does not include a PCB and a FPC to apply the common voltage and the driving voltage to the display panel 1 on which thin film transistors and signal wirings are formed. The power supplying part 300 supplying the common voltage and the driving voltage is provided outside the display substrate 1 so as to make the display substrate 1 relatively smaller. In addition, the power supplying part 300 is provided in the frame 2 supporting the display panel 1 and combined with the existing display panel 1, thereby eliminating the need to manufacture an additional component. Power supply members other than the above-described power supplying pins may be employed if the members can provide the common voltage and/or the driving voltage from the outside of the display panel 1 to the voltage pads 130, 131 and 140, as is suitable for the purpose described herein.

The illustrated embodiments provide a display apparatus which is capable of providing uniform brightness by supplying a driving voltage or a common voltage efficiently, and a manufacturing method thereof.

Although exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display apparatus comprising:
an insulating substrate comprising a display region;
a light emitting layer formed in the display region;
a first voltage pad applying a reference voltage to the display region, the first voltage pad being formed in a non-display region on the insulating substrate;
a frame supporting the insulating substrate and comprising an insulating material;
a second voltage pad formed on the frame and electrically connected with the first voltage pad; and
a power supplying part supplying power to the second voltage pad, the power supplying part being formed on the frame.

2. The display apparatus according to claim 1, wherein the second voltage pad comprises a conductive pattern formed on the frame.

3. The display apparatus according to claim 1, wherein the first voltage pad and the second voltage pad each comprise at least one of a metal layer, an ITO (indium tin oxide) layer and an IZO (indium zinc oxide) layer.

4. The display apparatus according to claim 2, wherein the second voltage pad contacts the first voltage pad.

5. The display apparatus according to claim 1, wherein the second voltage pad corresponds to the first voltage pad and is contacted with the first voltage pad.

6. The display apparatus according to claim 1, further comprising a driving voltage line formed in the display region,
wherein the reference voltage comprises a driving voltage applied to the driving voltage line.

7. The display apparatus according to claim 1, further comprising a common electrode formed in the display region,
wherein the reference voltage comprises a common voltage applied to the common electrode.

8. The display apparatus according to claim 1, wherein the light emitting layer emits light through a first side of the insulating substrate, the first side being not covered by the frame.

9. The display apparatus according to claim 1, further comprising an auxiliary voltage pad interconnecting a plurality of the first voltage pad.

10. The display apparatus according to claim 9, wherein each of pairs of the plurality of the first voltage pad are disposed opposite to each other relative to the display region.

11. The display apparatus according to claim 9, wherein the auxiliary voltage pad comprises a FPC (flexible printed circuit).

12. The display apparatus according to claim 9, wherein a plurality of the auxiliary voltage pad is arranged in parallel.

13. The display apparatus according to claim 1, further comprising an anisotropic conductive film provided between the first voltage pad and the second voltage pad.

14. A display apparatus comprising:
an insulating substrate comprising a display region;
a light emitting layer formed in the display region;
a voltage pad applying a reference voltage to the display region, the voltage pad being formed on a peripheral portion of the insulating substrate in a non-display region;
a frame supporting the insulating substrate and comprising an insulating material;
a conductive member formed on the frame and electrically connected with the voltage pad; and
a power supplying part supplying power to the conductive member, the power supplying part being formed on the frame.

15. A display apparatus comprising:
an insulating substrate comprising a display region;
a light emitting layer formed in the display region;
a voltage pad applying a reference voltage to the display region, the voltage pad being formed in a peripheral portion of a non-display region on the insulating substrate;
an insulating frame supporting the insulating substrate;
a power supplying pin formed on an inner surface of the frame and electrically connected with the voltage pad formed on the insulating substrate; and
a power supplying part supplying power to the power supplying pin, the power supplying part being formed on the frame.

16. The display apparatus according to claim 15, wherein the power supplying pin presses the insulating substrate.

17. The display apparatus according to claim 16, wherein the power supplying pin comprises a head contacting the voltage pad and a pressing member pressing the head against the voltage pad.

18. The display apparatus according to claim 17, wherein a length of the pressing member is adjustable in a direction perpendicular to the inner surface with respect to a plane of the frame.

19. The display apparatus according to claim 17, wherein the pressing member comprises a spring.

20. The display apparatus according to claim 15, wherein the voltage pad contacts the power supplying pin.
